(19) United States
(12) Patent Application Publication
(10) Pub. No.: US 2024/0015847 A1
(43) Pub. Date: Jan. 11, 2024

(54) A DIGITAL TELEPHONY SESSION INSTANTIATION AND CONTROL SYSTEM

(71) Applicant: Christopher DUTTON, Neutral Bay (AU)

(72) Inventor: Christopher DUTTON, Neutral Bay (AU)

(21) Appl. No.: 18/252,130

(22) PCT Filed: Nov. 18, 2021
(86) PCT No.: PCT/AU2021/051372

§ 371 Date: May 8, 2023

(30) Foreign Application Priority Data
Nov. 19, 2020 (AU) 2020904273

(51) Int. Cl. H04W 76/38

(52) U.S. Cl. CPC H04W 76/38

(57) ABSTRACT

A digital telephony session instantiation and control system comprises a plurality of mobile terminals in operable communication with a server executing a session controller across an IP network. Each mobile terminal is associated with a profile and the session controller is configured for matching non-disassociated user profiles and signalling to instantiate a digital telephony session between associated mobile. The session controller is configured to terminate the session upon expiry of a timer unless receiving first in-call input signals from both mobile terminals, terminates the session responsive to a second in-call input signal received from either mobile terminal and terminates the session and disassociates the profiles responsive to a third in-call input signal received from either mobile terminal.

### FIELD OF THE INVENTION

This invention relates generally to a digital telephony session instantiation and control system.

### BACKGROUND

US 20190273726 A1 (Shumsker et al.) 5 Sep. 2019 discloses a telecommunications management system (TMS) that receives an indication from a first user to participate in a telecommunication, identifies a characteristic of the first user and compare the characteristic with one or more characteristics of each user of a pool of users, selects, based on the comparison, a second user of the pool of users that matches the first user and initiates, responsive to selecting the matching second user, an anonymous telecommunications channel between the first user and the second user.

EP 1566953 A1 (Hägebarth) 24 Aug. 2005 discloses a method whereby a mobile terminal logs on to a contact server that manages a personal profile of a first subscriber and a first communication connection is established between the mobile terminal of the first subscriber and a second subscriber whose personal profile matches with the personal profile of the first subscriber according to a search profile associated with the first subscriber. In response to a switch command, the first communication connection is interrupted and a second communication connection is established between the mobile terminal of the first subscriber and a third subscriber whose personal profile as well matches with the personal profile of the first subscriber according to the search profile.

The present invention seeks to provide a digital telephony session instantiation and control system, which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE DISCLOSURE

There is provided herein a digital telephony session instantiation control system comprising a plurality of mobile terminals in operable communication with a session controller across an IP network.

Each mobile terminal is associated with a profile and the session controller is configured for matching first and second user profiles and signalling to instantiate a digital telephony session between first and second mobile terminals associated therewith.

Each mobile terminal may comprise a call controller having audio and video codecs for full duplex audio and video communication.

The session controller is configured to terminate the session upon expiry of a timer unless receiving first in-call input signals from both the first and second mobile terminals whereafter the timer is reset, or the session continues indefinitely until terminated by a user.

The session controller automatically terminating the session unless receiving the first in-call input signals from both the first and second mobile terminals reduces resource consumption, such as network bandwidth, processor utilisation and mobile terminal mobile device battery usage.

Alternatively, the session controller terminates the session responsive to a second in-call input signal received from either of the first and second mobile terminals whereafter the session controller may match the first profile with a third profile and instantiate a further digital telephony session between the first mobile terminal and a mobile terminal associated with the third profile.

The session controller is further configured to terminate the session responsive to a third in-call input signal received from one of the first and second mobile terminals and additionally disassociating the first and second profiles.

The session controller is configured for only matching non-disassociated user profiles. By not matching disassociated user profiles the session controller reduces telephony session instantiation resource consumption including processor utilisation and network bandwidth.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a digital telephony session instantiation and control system in accordance with a preferred embodiment of the present invention;

FIG. 2 shows an exemplary mobile terminal of the system of FIG. 1 in accordance with an embodiment;

FIG. 3 shows exemplary processing by the system of FIG. 1 in accordance with an embodiment; and

FIG. 4 shows an exemplary mobile terminal profile graph in accordance with an embodiment.

### DESCRIPTION OF EMBODIMENTS

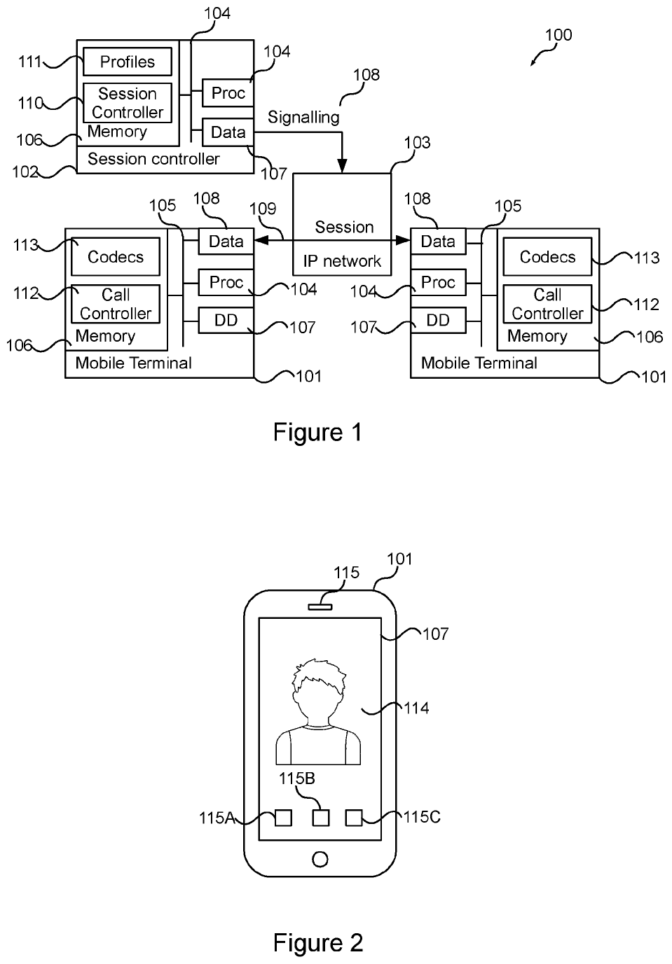

FIG. 1 shows a digital telephony session instantiation and control system 100 comprising a plurality of mobile terminals 101 in operable communication with a session controller server 102 across an IP network 103.

Each mobile terminal 101 comprises a processor 104 for processing digital data. A memory device 106 is in operable communication with the processor 104 via a system bus 105.

The memory device 106 is configured for storing digital data including computer program code instructions. These computer program code instructions may be logically divided into a plurality of computer program code instruction controllers.

In use, the processor 104 fetches these computer program code instructions and associated data from the memory device 106 for interpretation and execution of the functionality described herein. The controllers and associated data may be installed in the memory device 106 by way of a software application downloaded via the IP network 103.

Each mobile terminal 101 further comprises a digital display device 107 for displaying digital data. A haptic overlay may overlay the digital display 107 to receive user gestures in relation to digital information displayed thereon.

Each mobile terminal 101 may further comprise a data interface 108 for sending and receiving data across the IP network 103.

The session controller 110 similarly comprises a processor 104 memory device 106 and a data interface 107.

As will be described in further detail below, the session controller 110 is configured for signalling 108 via the IP network 103 to instantiate digital telephony sessions 109 between mobile terminals 101.

In this regard, the server may execute a session controller 110 which signals 108 the IP network 109 to instantiate the digital telephony sessions 109. The session controller 110 may instantiate sessions 109 between mobile terminals 101 associated with user profiles 111.

Each mobile terminal 101 may comprise a call controller 112 for handling a digital telephony call. The call controller 112 may comprise a plurality of audio and video codecs for voice and telephony call sessions 109 across the IP network 103.

FIG. 2 shows a mobile terminal 101 comprising the digital display 107 displaying a video representation 114 during a session 109 and playing out audio via an audio output device 115 thereof.

During a call, the call controller 112 may display a plurality of in-call inputs 115 for session control in the manner described below.

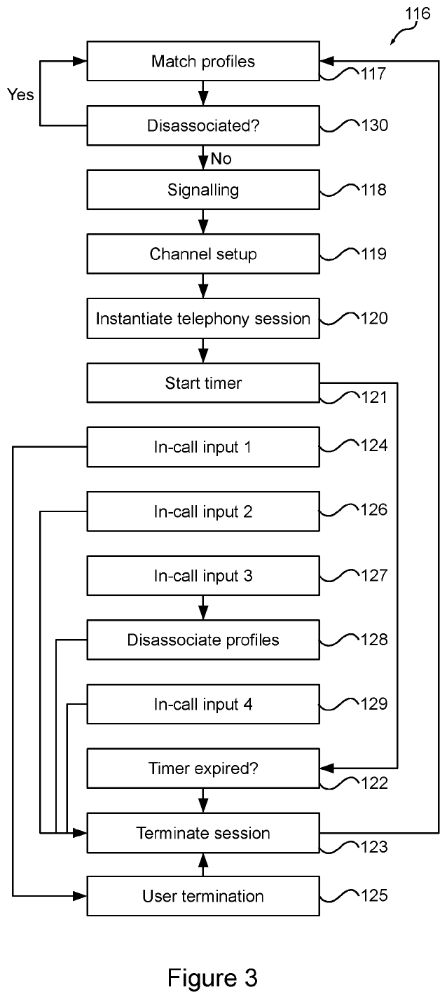

FIG. 3 shows exemplary processing 116 by the system 100 in accordance with an exemplary embodiment.

The processing 116 comprises the session controller 110 matching first and second profiles from the profiles 111 at step 117. Each profile 111 may be associated with various meta data, including demographic, preferential, historical meta data and the like. The session controller 110 may use a matching algorithm to match two profiles according to the associated meta data.

At step 118, the session controller 110 signals 108 across the IP network 109 to instantiate a digital telephony session 109 between first and second mobile terminals 101 associated with the first and second profiles. Each mobile terminal 101 may receive an incoming call signal allowing the user thereof to accept or reject the call. Incoming call signal may display a subset of the meta data of the profile associated with the incoming call. In embodiments, users of each mobile terminal may schedule times for receiving calls.

In embodiments, each mobile terminal 101 may enter a virtual “waiting room” wherein the mobile terminal 101 signals the session controller 110 with incoming call available availability signals indicating that the mobile terminal 101 may currently accept incoming calls. As such, the session controller 110 may match profiles 111 only associated with mobile terminals 101 from which incoming call current availability signals have been received.

At step 119, the session controller 110 and mobile terminals 101 cooperate to set up an IP channel between the mobile terminals 101 for the digital telephony session 109 and at step 120 the telephony session 109 is instantiated.

As such, the mobile terminals 101 exchange audio and video data in duplex.

At step 121, the session controller 110 instantiate a timer. The timer may be about 60 seconds, for example.

At step 122, upon expiry of the timer, the session controller 110 terminates the session 109 at step 123. Alternatively, upon expiry of the timer, the session controller 110 may inhibit functionality of the session 109, such as by blurring the screen, interrupting or muting the audio or the like.

Thereafter, the session controller 110 may further match further profiles at step 117 to repeat the process. For example, the session control server 102 may match the first user profile with a third user profile and signal to instantiate a further session 109 between a first mobile terminal and a mobile terminal associated therewith.

Alternatively, should the session controller 110 receive first in-call input 115A signals from both of the mobile terminals 101 at step 124, the session controller 110 may cancel the timer such that the session 109 may continue indefinitely until user-initiated termination at step 125. Alternatively, where the session controller 110 inhibits functionality of the session 109, such inhibition may be removed.

In alternative embodiments, the session controller 110 may reset the timer so as to essentially extend the duration of the call for a predetermined time period. For example, the in-call controls may comprise an in-call input allowing for the indefinite extension of the session 109 (i.e., until such time that the session 109 is terminated by either mobile terminal 101) and/or a further in-call input allowing for the extension of the session 109 for a predetermined time period.

With reference to FIG. 2, the first in-call input 115A is shown on-screen which, when selected by both of the users, causes the session 109 to continue indefinitely until the session 109 is terminated by one of the users. In this regard, once the first in-call input 115A is selected, a further call termination input (not shown) may be displayed for use by either user for terminating the session 109 at any time. Whereas the session controller 110 is responsive to the first in-call input 115A signals being received from both mobile terminals 101 in accordance with a preferred embodiment, in alternative embodiments, the session controller 110 may be responsive to the first in-call input 115A signal being received from only one of the mobile terminals 101 to extend the session 109.

Alternatively, responsive to a second in-call input 115B signal at step 126, the session controller 110 may terminate the session at step 123 and thereafter return to step 117.

Yet further alternatively, responsive to a third in-call input 115C signal at step 127, the session controller 110 may disassociates the profiles at step 128 and then terminate the session 109 at step 123.

By disassociating the profiles, the session controller 110 will thereafter not match the disassociated profiles at step 117.

FIG. 3 shows an exemplary user profile 111 graph 133 of three user profiles 111A-C with associated mobile terminals 101A-C.

As is illustrated, when matching profiles 111, the session controller 110 may match profiles 111 using meta data relationships 132 as described above. However, in the embodiment shown, a first profile 111A has been recorded as being disassociated with a second profile 111B by a disassociation key 113, responsive to the third in-call input 115C signal. The disassociation key 131 may take the form of a foreign key relationship in a relational database and may be indexed for fast searching to reduce resource consumption and time when matching profiles 111.

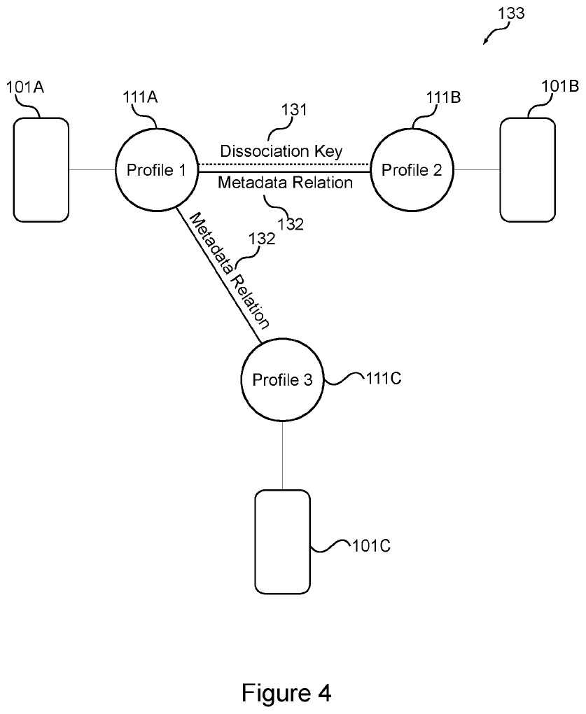

As such, as is further illustrated in FIG. 3, at step 130, when matching profiles using the graph 133, the session controller 110 would check for the disassociation key 131 wherein, if the disassociation key 131 were found, such as between the first profile 111A and the second profile 111B as shown in FIG. 4, the session controller 110 would not match the profiles 111A and 111B. However, the session controller 111 could match the first profile 111A with the third user profile 111C by the meta data relation 132 and therefore spend the resources to signal to set up a channel for instantiating a telephony session according to steps 118-120.

The session controller 110 may further inhibit communication functionality between mobile terminals 101 associated with respective disassociated profiles 111, such as by inhibiting text communication functionality between mobile terminals 101. Alternatively, the session controller 110 may enable text communication functionality between terminals 101 responsive to the second in-call input 115B.

In embodiments, the session controller 110 may analyse the audio and/or video data exchanged between the mobile terminals 101 to automatically terminate the session 109.

For example, the session controller 110 may analyse the audio to determine spoken word frequency and automatically terminate the session 109 when spoken word frequency falls beneath a threshold, such as when both or one user stops speaking or has limited speech input.

Alternatively, the session controller 110 may use a speech-to-text module to convert spoken words to text and infer tone using word categorisations and continue or terminate the session 109 depending on the tone of conversation between users of the mobile terminals 101. For example, the server may communicate with the IBM Watson™ Tone Analyzer service which uses linguistic analysis to detect emotional and language tones in the text.

Yet further, the session controller 110 may utilise facial recognition techniques to analyse facial gestures, such as smiling, frowning and or the like and continue or terminate the session 109 depending on the facial gestures of one or both users of the mobile terminals.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

The term “approximately” or similar as used herein should be construed as being within 10% of the value stated unless otherwise indicated.

1. A digital telephony session instantiation and control system comprising a plurality of mobile terminals in operable communication with a server executing a session controller across an IP network, each mobile terminal associated with a profile wherein the session controller is configured for matching non-disassociated user profiles and signalling to instantiate a digital telephony session between mobile terminals associated with the non-disassociated user profiles, wherein the session controller:
terminates the session upon expiry of a timer unless receiving first in-call input signals from both mobile terminals;
terminates the session responsive to a second in-call input signal received from either mobile terminal; and
terminates the session and disassociates the profiles responsive to a third in-call input signal received from either mobile terminal.

2. The system as claimed in claim 1, wherein the session controller is configured for resetting the timer responsive to the first in-call input signals.

3. The system as claimed in claim 1, wherein the session controller is configured for continuing the session responsive to the first in-call input signal until receiving a further session termination input signal from either mobile terminal.

4. The system as claimed in claim 3, wherein a session termination input is displayed on digital displays of both terminals responsive to the first in-call input signals.

5. The system as claimed in claim 1, wherein termination of the session upon expiry of the timer comprises inhibition of the session.

6. The system as claimed in claim 5, wherein inhibition of the session comprises at least one of screen blurring and interruption.

7. The system as claimed in claim 1, wherein the session controller is configured for recording a disassociation key between the profiles when disassociating the profiles.

8. The system as claimed in claim 7, wherein the disassociation key is search indexed.

9. The system as claimed in claim 1, wherein the session controller terminates the session responsive to a fourth in-call input received from one of the first and second mobile terminals and does not disassociate the first and second profiles.

10. The system as claimed in claim 2, wherein the session controller enables text communication functionality between the mobile terminals responsive to the first in-call input signals.

11. The system as claimed in claim 2, wherein the session controller inhibits text communication functionality between mobile terminals associated with disassociated profiles.

12. The system as claimed in claim 1, wherein the session controller matches the profiles in accordance with meta data associated with the user profiles.

13. The system as claimed in claim 12, wherein the meta data comprises demographic meta data.

14. The system as claimed in claim 12, wherein, when instantiating the session, each mobile terminal receives an incoming call on-screen notification comprising a subset of the meta data.

15. The system as claimed in claim 1, wherein after terminating the session, the session controller matches a further non-disassociated user profile and signals to instantiate a further digital telephony session between one of the mobile terminals and a further mobile terminal associated with the further non-disassociated user profile.

16. The system as claimed in claim 1, wherein each mobile terminal comprises a call controller having audio and video codecs for duplex audio and video communication.

17. The system as claimed in claim 1, wherein the session controller analyses at least one of audio and/or video data exchanged between the mobile terminals to automatically terminate the session.

18. The system as claimed in claim 1, wherein the session controller analyses the audio to determine spoken word frequency and automatically terminates the session when spoken word frequency falls beneath a threshold.

19. The system as claimed in claim 1, wherein the session controller converts spoken words to text, and terminates the session depending on the text.

20. The system as claimed in claim 1, wherein the session controller is responsive to incoming call current availability signals from mobile terminals and wherein, when matching user profiles, the session controller is configured for only matching user profiles associated with mobile terminals for which incoming call current availability signals have been received.
